(19) United States
(12) Patent Application Publication
(10) Pub. No.: US 2025/0386873 A1
(43) Pub. Date: Dec. 25, 2025

(54) AEROSOL GENERATING DEVICE AND OPERATING METHOD THEREOF

(71) Applicant: KT&G CORPORATION, Daejeon (KR)

(72) Inventors: Yong Hwan KIM, Gyeonggi-do (KR); Young Bum KWON, Gyeonggi-do (KR); Dong Sung KIM, Seoul (KR); Hun 11 LIM, Seoul (KR); Seok Su JANG, Daejeon (KR)

(73) Assignee: KT&G CORPORATION, Daejeon (KR)

(21) Appl. No.: 18/566,709

(22) PCT Filed: Sep. 4, 2023
(86) PCT No.: PCT/KR2023/013171

§ 371 Date: Dec. 4, 2023

(30) Foreign Application Priority Data
Sep. 5, 2002 (KR) 10-2022-0112374
Dec. 30, 2022 (KR) 10-2022-0191049

(51) Int. Cl. A24F 40/57; A24F 40/20; G05D 23/24

(52) U.S. Cl. CPC A24F 40/57; A24F 40/20; G05D 23/2401

(57) ABSTRACT

Provided is an aerosol generating device including a heater configured to heat a cigarette, a temperature sensor configured to measure a temperature of the heater, a timer configured to count a current date, and a controller configured to calculate a temperature increase time of the cigarette by using the temperature sensor, set a threshold value based on the current date, when the temperature increase time is less than the threshold value, supply power to the heater according to a default temperature profile, and when the temperature increase time is greater than or equal to the threshold value, supply power to the heater according to a first correction profile.

### TECHNICAL FIELD

The present disclosure relates to an aerosol generating device and an operating method thereof.

### BACKGROUND ART

Recently, the demand for smoking methods to replace traditional cigarettes has increased. For example, there is an increasing demand for a method of generating an aerosol by heating an aerosol generating material in a cigarette, rather than using a method of burning a cigarette to generate an aerosol. Accordingly, studies on heating-type cigarettes or heating-type aerosol generating devices have been actively conducted.

The specific heat of moisture is higher than air, and the heat capacity of moisture is greater than air at the same temperature. As a result, when a user inhales an aerosol having a high moisture content, the aerosol may feel hotter than air of the same temperature.

### DISCLOSURE OF INVENTION

### Technical Problem

In an aerosol generating device, controlling the temperature of a heater is very important.

The surrounding environment needs to be considered in controlling the temperature of the heater of the aerosol generating device. In particular, in controlling the temperature of the heater, there is a need to reflect the seasonal features when it is hot and humid in summer and when it is cold and dry in winter.

The task of the disclosure is to distinguish between summer and other seasons by using a timer included in the aerosol generating device, and to precisely control the temperature of the heater of the aerosol generating device by reflecting the seasonal features.

The disclosure provides an aerosol generating device capable of distinguishing between a general cigarette and an over-humidified cigarette, and an operating method of the aerosol generating device.

The disclosure provides an aerosol generating device including a temperature profile corresponding to each of the general cigarette and the over-humidified cigarette, and an operation method of the aerosol generating device.

### Solution to Problem

According to an embodiment, an aerosol generating device includes a heater configured to heat a cigarette, a temperature sensor configured to measure a temperature of the heater, a timer configured to count a current date, and a controller configured to calculate a temperature increase time of the cigarette by using the temperature sensor, set a threshold value based on the current date, when the temperature increase time is less than the threshold value, supply power to the heater according to a default temperature profile, and when the temperature increase time is greater than or equal to the threshold value, supply power to the heater according to a first correction profile.

According to an embodiment, an operation method of an aerosol generating apparatus includes heating a cigarette by a heater, measuring a temperature of the heater by a temperature sensor, counting a current date by a timer, and controlling power supplied to the heater through a control signal, wherein the controlling of the power includes calculating a temperature increase time of the cigarette by using the temperature sensor, setting a threshold value based on the current date, when the temperature increase time is less than the threshold value, supplying power to the heater according to a default temperature profile, and, when the temperature increase time is greater than or equal to the threshold value, supplying power to the heater according to a first correction profile.

### Advantageous Effects of Invention

An aerosol generating device and an operation method thereof, according to various embodiments of the disclosure, may distinguish between general cigarettes and over-humidified cigarettes based on the temperature increase time of a cigarette.

In addition, various embodiments of the disclosure may provide a temperature profile corresponding to each of the general cigarette and the over-humidified cigarette.

In addition, various embodiments of the disclosure may distinguish between summer and the other seasons, and reflect the seasonal features to precisely control the temperature of the heater of the aerosol generating device.

However, effects of the present disclosure are not limited to the above effects, and effects that are not mentioned could be clearly understood by one of ordinary skill in the art from the present specification and the attached drawings.

### BRIEF DESCRIPTION OF DRAWINGS

FIGS. 1 to 3 are views showing examples in which a cigarette is inserted into an aerosol generating device;

FIGS. 4 and 5 illustrate examples of a cigarette;

FIG. 6 is a block diagram of an aerosol generating device according to another embodiment;

FIG. 7A is a perspective view showing an exterior of an aerosol generating device according to an embodiment;

FIG. 7B is a perspective view showing an operating state of an aerosol generating device from which some components are separated, according to the embodiment shown in FIG. 7A;

FIG. 8 is an example view for explaining a default temperature profile of an aerosol generating device;

FIG. 9A is an example view for explaining a first correction profile of an aerosol generating device;

FIG. 9B is an example view for explaining a second correction profile of an aerosol generating device; and

FIG. 10 is a flowchart illustrating an operation method of an aerosol generating device, according to an embodiment.

### BEST MODE FOR CARRYING OUT THE INVENTION

According to an embodiment, an aerosol generating device includes a heater heating a cigarette, a temperature sensor configured to measure a temperature of the heater, a timer counting a current date, and a controller configured to control power supplied to the heater through a control signal, wherein the controller is further configured to calculate a temperature increase time of the cigarette by using the temperature sensor, set a threshold value based on the current date, when the temperature increase time is less than the threshold value, supply power to the heater according to a default temperature profile, and when the temperature increase time is greater than or equal to the threshold value, supply power to the heater according to a first correction profile.

According to an embodiment, the controller may further be configured to distinguish between a first season and a second season different from the first season based on the current date, and set the threshold value as a first threshold value corresponding to the first season and a second threshold value corresponding to the second season.

According to an embodiment, the default temperature profile may include a first preheating section and a first smoking section, the first correction profile may include a second preheating section and a second smoking section, and the second preheating section may be greater than the first preheating section.

According to an embodiment, the first preheating section may include a first preheating rising section, a first preheating maintaining section, and a first preheating descending section, the second preheating section may include a second preheating rising section, a 2-1st preheating maintaining section, a second preheating descending section, and a 2-2nd preheating maintaining section, and the first preheating rising section may be less than the second preheating rising section.

According to an embodiment, the 2-1st preheating maintaining section may be greater than the first preheating maintaining section, and a temperature change in the second preheating descending section may be greater than the temperature change in the first preheating descending section.

According to an embodiment, the first smoking section may include a first smoking descending section and a first smoking maintaining section, and the second smoking section may include a second smoking maintaining section.

According to an embodiment, the controller may further be configured to distinguish between a first season and a second season different from the first season based on the current date, supply power to the heater according to the first correction profile for the first season, and supply power to the heater according to the second correction profile different from the first correction profile for the second season.

According to an embodiment, the first correction profile may include a second preheating section and a second smoking section, the second correction profile may include a third preheating section and a third smoking section, the second preheating section may include a second preheating rising section, a 2-1st preheating maintaining section, a second preheating descending section, and a 2-2nd preheating maintaining section, and the third preheating section may include a third preheating rising section, a 3-1^{st} preheating maintaining section, a third preheating descending section, and a 3-2nd preheating maintaining section, wherein a time of a sum of the 2-1st preheating maintaining section, the second preheating descending section, and the 2-2nd preheating maintaining section may be greater than a time of a sum of the 3-1^{st} preheating maintaining section, the third preheating descending section, and the 3-2nd preheating maintaining section.

### Mode for the Invention

With respect to the terms used to describe the various embodiments, general terms which are currently and widely used are selected in consideration of functions of structural elements in the various embodiments of the present disclosure. However, meanings of the terms can be changed according to intention, a judicial precedence, the appearance of new technology, and the like. In addition, in certain cases, a term which is not commonly used can be selected. In such a case, the meaning of the term will be described in detail at the corresponding portion in the description of the present disclosure. Therefore, the terms used in the various embodiments of the present disclosure should be defined based on the meanings of the terms and the descriptions provided herein.

In addition, unless explicitly described to the contrary, the word “comprises” and variations such as “comprises” or “comprising” will be understood to imply the inclusion of stated elements but not the exclusion of any other elements. In addition, the terms “-er”, “-or”, and “module” described in the specification mean units for processing at least one function and operation and can be implemented by hardware components or software components and combinations thereof.

Hereinafter, the present disclosure will now be described more fully with reference to the accompanying drawings, in which exemplary embodiments of the present disclosure are shown such that one of ordinary skill in the art may easily work the present disclosure. The disclosure may, however, be embodied in many different forms and should not be construed as being limited to the embodiments set forth herein.

Hereinafter, embodiments of the present disclosure will be described in detail with reference to the drawings.

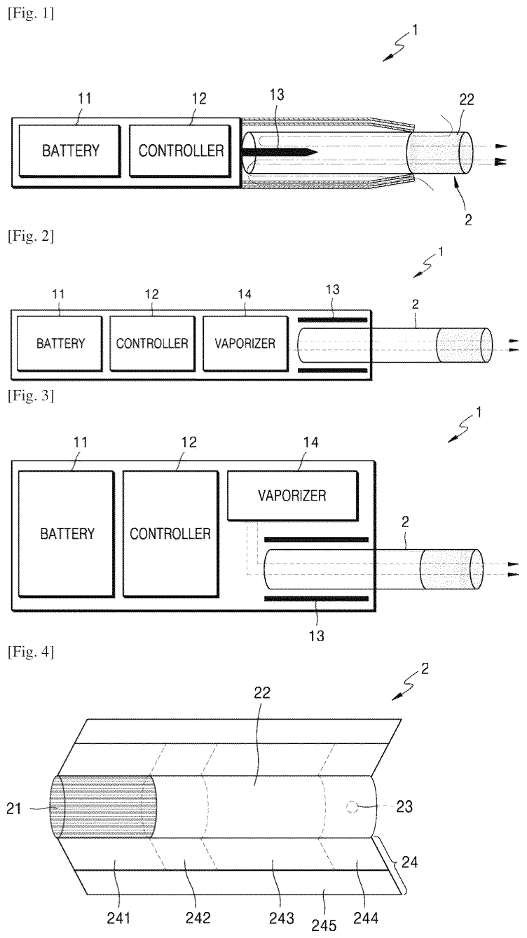

FIGS. 1 through 3 are diagrams showing examples in which a cigarette is inserted into an aerosol generating device.

Referring to FIG. 1, an aerosol generating device 1 includes a battery 11, a controller 12, and a heater 13. Referring to FIGS. 2 and 3, the aerosol generating device 1 further includes a vaporizer 14. A cigarette 2 may be inserted into an internal space of the aerosol generating device 1.

The elements related to the embodiment are illustrated in the aerosol generator 1 of FIGS. 1 to 3. Therefore, one of ordinary skill in the art would appreciate that other universal elements than the elements shown in FIGS. 1 to 3 may be further included in the aerosol generator 1.

Also, although it is shown that the aerosol generating device 1 includes the heater 13 in FIGS. 2 and 3, the heater 13 may be omitted if necessary.

In FIG. 1, the battery 11, the controller 12, and the heater 13 are arranged in a row. Also, FIG. 2 shows that the battery 11, the controller 12, the vaporizer 14, and the heater 13 are arranged in a row. Also, FIG. 3 shows that the vaporizer 14 and the heater 13 are arranged in parallel with each other. However, an internal structure of the aerosol generator 1 is not limited to the examples shown in FIGS. 1 to 3. That is, according to a design of the aerosol generator 1, arrangement of the battery 11, the controller 12, the heater 13, and the vaporizer 14 may be changed.

When the cigarette 2 is inserted into the aerosol generator 1, the aerosol generator 1 operates the heater 13 and/or the vaporizer 14 to generate aerosol from the cigarette 2 and/or the vaporizer 14. The aerosol generated by the heater 13 and/or the vaporizer 14 may be transferred to a user via the cigarette 2.

If necessary, even when the cigarette 2 is not inserted in the aerosol generator 1, the aerosol generator 1 may heat the heater 13.

The battery 11 supplies the electric power used to operate the aerosol generator 1. For example, the battery 11 may supply power for heating the heater 13 or the vaporizer 14 and supply power for operating the controller 12. In addition, the battery 11 may supply power for operating a display, a sensor, a motor, and the like installed in the aerosol generator 1.

The controller 12 controls the overall operation of the aerosol generator 1. In detail, the controller 12 may control operations of other elements included in the aerosol generator 1, as well as the battery 11, the heater 13, and the vaporizer 14. Also, the controller 12 may check the status of each component in the aerosol generator 1 to determine whether the aerosol generator 1 is in an operable state.

The controller 12 includes at least one processor. A processor may be implemented as an array of a plurality of logic gates or may be implemented as a combination of a general-purpose microprocessor and a memory in which a program executable in the microprocessor is stored. It will be understood by one of ordinary skill in the art that the processor can be implemented in other forms of hardware.

The heater 13 may be heated by the electric power supplied from the battery 11. For example, when the cigarette is inserted in the aerosol generator 1, the heater 13 may be located outside the cigarette. Therefore, the heated heater 13 may raise the temperature of an aerosol generating material in the cigarette.

The heater 13 may be an electro-resistive heater. For example, the heater 13 includes an electrically conductive track, and the heater 13 may be heated as current flows through the electrically conductive track. However, the heater 13 is not limited to the above example, and any type of heater may be used provided that the heater is heated to a desired temperature. Here, the desired temperature may be set in advance on the aerosol generator 1, or may be set by a user.

In addition, in another example, the heater 13 may include an induction heating type heater. In detail, the heater 13 may include an electrically conductive coil for heating the cigarette in an induction heating method, and the cigarette may include a susceptor that may be heated by the induction heating type heater.

For example, the heater 13 may include a tubular type heating element, a plate type heating element, a needle type heating element, or a rod type heating element, and may heat the inside or outside of the cigarette 2 according to the shape of the heating element.

Also, there may be a plurality of heaters 13 in the aerosol generator 1. Here, the plurality of heaters 13 may be arranged to be inserted into the cigarette 2 or on the outside of the cigarette 2. Also, some of the plurality of heaters 13 may be arranged to be inserted into the cigarette 2 and the other may be arranged on the outside of the cigarette 2. In addition, the shape of the heater 13 is not limited to the example shown in FIGS. 1 to 3, but may be manufactured in various shapes.

The vaporizer 14 may generate aerosol by heating a liquid composition and the generated aerosol may be delivered to the user after passing through the cigarette 2. In other words, the aerosol generated by the vaporizer 14 may move along an air flow passage of the aerosol generator 1, and the air flow passage may be configured for the aerosol generated by the vaporizer 14 to be delivered to the user through the cigarette.

For example, the vaporizer 14 may include a liquid storage unit, a liquid delivering unit, and a heating element, but is not limited thereto. For example, the liquid storage unit, the liquid delivering unit, and the heating element may be included in the aerosol generator 1 as independent modules.

The liquid storage may store a liquid composition. For example, the liquid composition may be a liquid including a tobacco-containing material having a volatile tobacco flavor component, or a liquid including a non-tobacco material. The liquid storage unit may be attached to/detached from the vaporizer 14 or may be integrally manufactured with the vaporizer 14.

For example, the liquid composition may include water, a solvent, ethanol, plant extract, spices, flavorings, or a vitamin mixture. The spices may include menthol, peppermint, spearmint oil, and various fruit-flavored ingredients, but are not limited thereto. The flavorings may include ingredients capable of providing various flavors or tastes to a user. Vitamin mixtures may be a mixture of at least one of vitamin A, vitamin B, vitamin C, and vitamin E, but are not limited thereto. In addition, the liquid composition may include an aerosol forming agent such as glycerin and propylene glycol.

The liquid delivery element may deliver the liquid composition of the liquid storage to the heating element. For example, the liquid delivery element may be a wick such as cotton fiber, ceramic fiber, glass fiber, or porous ceramic, but is not limited thereto.

The heating element is an element for heating the liquid composition delivered by the liquid delivery element. For example, the heating element may be a metal heating wire, a metal hot plate, a ceramic heater, or the like, but is not limited thereto. In addition, the heating element may include a conductive filament such as nichrome wire and may be positioned as being wound around the liquid delivery element. The heating element may be heated by a current supply and may transfer heat to the liquid composition in contact with the heating element, thereby heating the liquid composition. As a result, aerosol may be generated.

For example, the vaporizer 14 may be referred to as a cartomizer or an atomizer, but is not limited thereto.

In addition, the aerosol generator 1 may further include universal elements, in addition to the battery 11, the controller 12, the heater 13, and the vaporizer 14. For example, the aerosol generator 1 may include a display capable of outputting visual information and/or a motor for outputting tactile information. Also, the aerosol generating device 1 may include at least one sensor (a puff sensor, a temperature sensor, an aerosol generating article insertion detecting sensor, etc.). Also, the aerosol generator 1 may be manufactured to have a structure, in which external air may be introduced or internal air may be discharged even in a state where the cigarette 2 is inserted.

Although not shown in FIGS. 1 to 3, the aerosol generator 1 may configure a system with an additional cradle. For example, the cradle may be used to charge the battery 11 of the aerosol generator 1. Alternatively, the heater 13 may be heated in a state in which the cradle and the aerosol generator 1 are coupled to each other.

The cigarette 2 may be similar as a general combustive cigarette. For example, the cigarette 2 may be divided into a first portion including an aerosol generating material and a second portion including a filter, etc. Alternatively, the second portion of the cigarette 2 may also include an aerosol generating material. For example, an aerosol generating material made in the form of granules or capsules may be inserted into the second portion.

The entire first portion may be inserted into the aerosol generator 1 and the second portion may be exposed to the outside. Alternatively, only a portion of the first portion may be inserted into the aerosol generator 1 or the entire first portion and a portion of the second portion may be inserted into the aerosol generator 1. The user may puff aerosol while holding the second portion by the mouth of the user. In this case, the aerosol is generated by the external air passing through the first portion, and the generated aerosol passes through the second portion and is delivered to the user's mouth.

For example, the outside air may be introduced through at least one air passage formed in the aerosol generator 1. For example, the opening and closing of the air passage formed in the aerosol generator 1 and/or the size of the air passage may be adjusted by a user. Accordingly, the amount and the quality of smoking may be adjusted by the user. As another example, the external air may flow into the cigarette 2 through at least one hole formed in a surface of the cigarette 2.

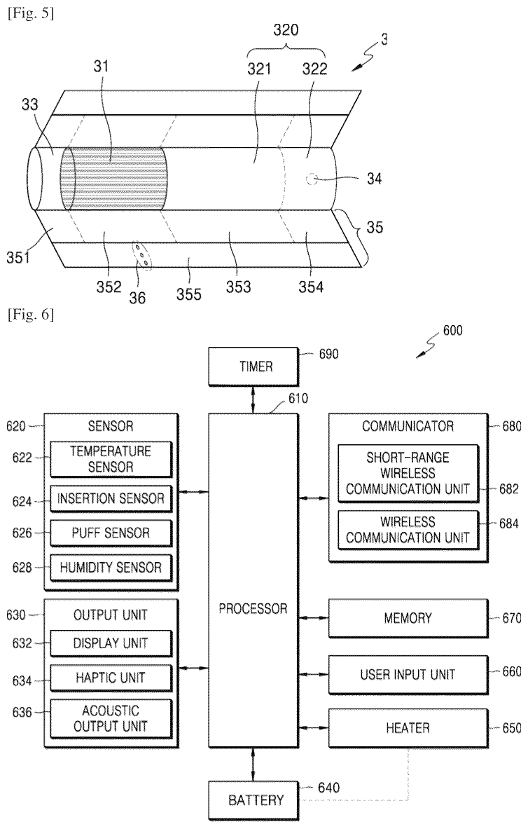

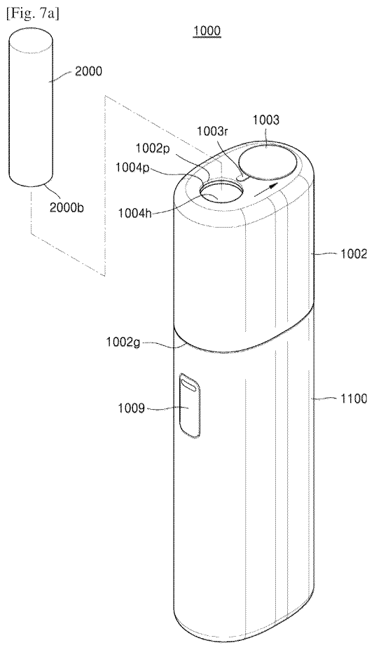

Hereinafter, examples of the cigarette 2 will be described with reference to FIGS. 4 and 5.

FIGS. 4 and 5 illustrate examples of a cigarette.

Referring to FIG. 4, the cigarette 2 includes a tobacco rod 21 and a filter rod 22. FIG. 4 illustrates that the filter rod 22 includes a single segment, but is not limited thereto. In other words, the filter rod 22 may include a plurality of segments. For example, the filter rod 22 may include a first segment configured to cool an aerosol and a second segment configured to filter a certain component included in the aerosol. Also, according to necessity, the filter rod 22 may further include at least one segment configured to perform other functions.

A diameter of the cigarette 2 may range from about 5 mm to about 9 mm, and a length of the cigarette 2 may be about 48 mm, but embodiments are not limited thereto. For example, the length of the tobacco rod 21 may be about 12 mm, the length of the first segment of the filter rod 22 may be about 10 mm, the length of the second segment of the filter rod 22 may be about 14 mm, and the length of the third second segment of the filter rod 22 may be about 12 mm, but embodiments are not limited thereto.

The cigarette 20 may be packaged via at least one wrapper 24. The wrapper 24 may have at least one hole through which external air may be introduced or internal air may be discharged. For example, the cigarette 2 may be packaged via one wrapper 24. As another example, the cigarette 2 may be doubly packaged via at least two wrappers 24. For example, the tobacco rod 21 may be packaged via a first wrapper 241, and the filter rod 22 may be packaged via wrappers 242, 243, 244. Also, the entire cigarette 2 may be re-packaged by a fifth wrapper 245, which is a single wrapper When the filter rod 22 includes a plurality of segments, each segment may be packaged via separate wrapper 242, 243, 244.

The first wrapper 241 and the second wrapper 242 may be manufactured with a general filter wrapper. For example, the first wrapper 241 and the second wrapper 242 may be a porous wrapper or a non-porous wrapper. Also, the first wrapper 241 and the second wrapper 242 may be manufactured with oil-resistant paper and/or aluminum laminating paper wrapper.

The third wrapper 243 may be manufactured with a hard wrapper. For example, the basis weight of the third wrapper 243 may be in a range of about 88 g/m² to about 96 g/m₂, preferably in a range of about 90 g/m² to about 94 g/m². In addition, the thickness of the third wrapper 243 may be in a range of about 120 μm to about 130 μm, for example, about 125 μm.

The fourth wrapper 244 may be manufactured with an oil-resistant hard wrapper. For example, the basis weight of the fourth wrapper 244 may be in a range of about 88 g/m 2 to about 96 g/m², for example, in a range of about 90 g/m² to about 94 g/m². In addition, the thickness of the fourth wrapper 244 may be in a range of about 120 μm to about 130 μm, for example, about 125 μm.

The fifth wrapper may be manufactured with a microbiological filtered white (MFW). Here, the MFW refers to a paper that is specially prepared to have a tensile strength, water resistance, smoothness, etc. that are improved more than ordinary paper. For example, the basis weight of the fifth wrapper 245 may be in a range of about 57 g/m² to about 63 g/m², for example, about 60 g/m². In addition, the thickness of the fifth wrapper 245 may be in a range of about 64 μm to about 70 μm, preferably about 67 μm.

The fifth wrapper 245 may include a predetermined material. Here, silicon may be used as an example of the certain material. However, embodiments of the present disclosure are not limited thereto. For example, silicon has properties such as heat resistance resulting in little change with temperature, non-oxidizing nature, resistance to various chemicals, water repellency, electrical insulation, or the like. However, even if it is not silicon, any material having the above-described characteristics may be applied (or coated) to the fifth wrapper 245.

The fifth wrapper 245 may prevent combustion of the cigarette 2. For example, if the tobacco rod 210 is heated by the heater 13, the cigarette 2 may be combusted. In detail, when the temperature of any one of the materials included in the tobacco rod 310 rises above the ignition point, the cigarette 2 may be combusted. Even in this case, because the fifth wrapper 245 includes a non-combustible material, the cigarette 2 may be prevented from being combusted.

In addition, the fifth wrapper 245 may prevent the aerosol generating device 1 from being contaminated by materials generated in the cigarette 2. Liquid may be generated from the cigarette 2 by a user's puff. For example, because the aerosol generated from the cigarette 2 is cooled by air from the outside, liquid (for example, moisture, etc.) may be generated. Because the cigarette 2 is wrapped by the fifth wrapper 245, liquid generated from the cigarette 2 may be prevented from leaking outside the cigarette 2.

The tobacco rod 21 may include an aerosol generating material. For example, the aerosol generating material may include at least one of glycerin, propylene glycol, ethylene glycol, dipropylene glycol, diethylene glycol, triethylene glycol, tetraethylene glycol, and oleyl alcohol, but it is not limited thereto. Also, the tobacco rod 21 may include other additives, such as flavors, a wetting agent, and/or organic acid. Also, the tobacco rod 21 may include a flavored liquid, such as menthol or a moisturizer, which is sprayed onto the tobacco rod 21.

The tobacco rod 21 may be manufactured in various forms. For example, the tobacco rod 21 may be formed as a sheet or a strand. Also, the tobacco rod 21 may be formed as a pipe tobacco, which is formed of tiny bits cut from a tobacco sheet. Also, the tobacco rod 21 may be surrounded by a heat conductive material. For example, the heat-conducting material may be, but is not limited to, a metal foil such as aluminum foil. For example, the heat conductive material surrounding the tobacco rod 21 may uniformly distribute heat transmitted to the tobacco rod 21, and thus, the heat conductivity applied to the tobacco rod may be increased and taste of the tobacco may be improved. Also, the heat conductive material surrounding the tobacco rod 21 may function as a susceptor heated by the induction heater. Here, although not illustrated in the drawings, the tobacco rod 21 may further include an additional susceptor, in addition to the heat conductive material surrounding the tobacco rod 21.

The filter rod 22 may include a cellulose acetate filter. Shapes of the filter rod 22 are not limited. For example, the filter rod 22 may include a cylinder-type rod or a tube-type rod having a hollow inside. Also, the filter rod 22 may include a recess-type rod. When the filter rod 22 includes a plurality of segments, at least one of the plurality of segments may have a different shape.

The first segment of the filter rod 22 may include a cellulose acetate filter. For example, the first segment may be a tube-shaped structure including a hollow inside. When the heater 13 is inserted by the first segment, the inner material of the tobacco rod 21 may be prevented from being pushed backward, and a cooling effect of the aerosol may be generated. A diameter of the hollow included in the first segment may be implemented within a range of about 2 mm to about 4.5 mm, but embodiments are not limited thereto.

A length of the first segment may be implemented within a range of about 4 mm to about 30 mm, but embodiments are not limited thereto. For example, the length of the first segment may be about 10 mm, but is not limited thereto.

The rigidity of the first segment may be controlled by controlling the content of the plasticizer during the manufacture of the first segment. In addition, the first segment may be manufactured by inserting a structure such as a film or tube made of the same material or different materials to the inside (i.e., the hollow) of the first segment.

The second segment of the filter rod 22 cools the aerosol generated by heating the tobacco rod 21 through the heater 13. Accordingly, the user may inhale the aerosol cooled to an appropriate temperature.

The length or diameter of the second segment may be determined in various ways according to the form of cigarette 2. For example, the length of the second segment may be implemented appropriately within a range of about 7 mm to about 20 mm. For example, the length of the second segment may be about 14 mm, but is not limited thereto.

The second segment may be made by weaving polymer fibers. In this case, flavoring liquid may be applied to fibers made of polymer. Alternatively, the second segment may be manufactured by weaving a separate fiber onto which flavoring liquid is applied and a fiber made of polymer together. Alternatively, the second segment may be formed by a crimped polymer sheet.

For example, polymer may be formed of a material selected from a group consisting of polyethylene (PE), polypropylene (PP), polyvinyl chloride (PVC), polyethylene terephthalate (PET), polylactic acid (PLA), cellulose acetate (CA), and aluminum foil.

As the second segment is formed by a polymer fiber or a crimped polymer sheet, the second segment may include a single or a plurality of channels extending in a longitudinal direction. Here, the channel refers to a passage through which a gas (e.g., an air or aerosol) passes.

For example, the second segment consisting of a crimped polymer sheet may be formed of a material having a thickness between about 5 μm and about 300 μm, for example, between about 10 μm, and about 250 μm. In addition, the entire surface area of the second segment may be between about 300 mm²/mm and about 1,000 mm²/mm. In addition, an aerosol cooling element may be formed of a material having a specific surface area of between about 10 mm²/mg and about 100 mm²/mg.

The second segment may include a thread containing volatile flavor components. Here, volatile flavor components may be menthol, but are not limited thereto. For example, in a thread, a sufficient amount of menthol may be filled so that menthol of more than 1.5 mg may be provided to the second segment.

The third segment of the filter rod 22 may include a cellulose acetate filter. The length of the third segment may be implemented appropriately within a range of about 4 mm to about 20 mm. For example, the length of the third segment may be about 12 mm, but is not limited thereto.

The third segment may be manufactured such that a flavor is generated by spraying flavoring liquid on the third segment. Alternatively, a separate fiber to which a flavoring liquid is applied may be inserted into the third segment. The aerosol generated by the tobacco rod 21 is cooled as it passes through the second segment of the filter rod 22, and the cooled aerosol is delivered to the user through the third segment. Thus, when a flavoring element is added to the third segment, the persistence of the flavor transmitted to the user may be enhanced.

Also, the filter rod 22 may include at least one capsule 23. Here, the capsule 23 may generate a flavor or an aerosol. For example, the capsule 23 may have a configuration in which a liquid containing a flavoring material is wrapped with a film. For example, the capsule 23 may have a spherical or cylindrical shape, but is not limited thereto.

Referring to FIG. 5, the cigarette 3 includes additionally a front-end plug 33. The front-end plug 33 may be located on a side of the tobacco rod 31, the side facing the filter rod 32. The front-end plug 33 may prevent the tobacco rod 31 from escaping to the outside and may prevent a liquefied aerosol from flowing from the tobacco rod 31 into an aerosol generating device (1 of FIGS. 1 to 3) during smoking.

The filter rod 32 may include a first segment 321 and second segment 322. Here, the first segment 321 may correspond to the first segment of the filter rod 22 of FIG. 4, and the second segment 322 may correspond to the second segment of the filter rod 22 of FIG. 4.

The diameter and the total length of the cigarette 3 may correspond to the diameter and the total length of the cigarette 2 of FIG. 4. For example, the length of the front-end plug 33 may be about 7 mm, the length of the tobacco rod 31 may be about 15 mm, the length of the first segment 321 may be about 12 mm, and the length of the second segment 322 may be about 14 mm, but embodiments are not limited thereto.

The cigarette 3 may be wrapped by at least one wrapper 35. The wrapper 35 may have at least one hole through which external air may be introduced or internal air may be discharged. For example, the front-end plug 33 may be packaged via a first wrapper 351, the tobacco rod 31 may be packaged via a second wrapper 352, the first segment 321 may be packaged via a third wrapper 353, and the second segment 322 may be packaged via a fourth wrapper 354. Also, the entire cigarette 3 may be re-wrapped by a fifth wrapper 355.

Also, the fifth wrapper 355 may have at least one hole 36. For example, the hole 36 may be formed in an area surrounding the tobacco rod 31, but is not limited thereto. The perforation 36 may serve to transfer heat generated by the heater 13 illustrated in FIGS. 2 and 3 to the inside of the tobacco rod 31.

Also, the second segment 322 may include at least one capsule 34. Here, the capsule 34 may generate a flavor or an aerosol. For example, the capsule 34 may have a configuration in which a liquid containing a flavoring material is wrapped with a film. For example, the capsule 34 may have a spherical or cylindrical shape, but is not limited thereto.

The first wrapper 351 may be a combination of a general filter wrapper and a metal foil such as aluminum foil. For example, the overall thickness of the first wrapper 351 may be within a range of about 45 μm to about 55 μm, for example, about 50.3 μm. In addition, the thickness of a metal foil of the first wrapper 351 may be within a range of about 6 μm to about 7 μm, for example, about 6.3 μm. In addition, the basis weight of the first wrapper 351 may be within about 50 g/m² to about 55 g/m², for example, about 53 g/m².

The second wrapper 352 and the third wrapper 353 may be made of a general filter wrapper. For example, the second wrapper 352 and the third wrapper 353 may be a porous wrapper or a non-porous wrapper.

For example, the porosity of the second wrapper 352 may be 35,000 cu, but is not limited thereto. In addition, the thickness of the second wrapper 352 may be within a range of about 70 μm to about 80 μm, for example, about 78 μm. In addition, the basis weight of the second wrapper 352 may be within about 20 g/m² to about 25 g/m², for example, about 23.5 g/m².

For example, the porosity of the third wrapper 353 may be 24,000 cu, but is not limited thereto. In addition, the thickness of the third wrapper 353 may be within a range of about 60 μm to about 70 μm, for example, about 68 μm. In addition, the basis weight of the third wrapper 353 may be within about 20 g/m² to about 25 g/m², for example, about 21 g/m².

The fourth wrapper 354 may be made of a PLA laminating paper. Here, the PLA laminating paper refers to a three-layer paper including a paper layer, a PLA layer, and a paper layer. For example, the thickness of the fourth wrapper 354 may be within a range of about 100 μm to about 120 μm, for example, about 110 μm. In addition, the basis weight of the fourth wrapper 354 may be within a range of about 80 g/m² to about 100 g/m², for example, about 88 g/m².

The fifth wrapper may be manufactured with a MFW. Here, the MFW refers to a paper that is specially prepared to have a tensile strength, water resistance, smoothness, etc. that are improved more than ordinary paper. For example, the basis weight of the fifth wrapper 355 may be within about 57 g/m² to about 63 g/m², for example, about 60 g/m². In addition, the thickness of the fifth wrapper 355 may be within a range of about 64 μm to about 70 μm, for example, about 67 μm.

A certain material may be added into the fifth wrapper 355. Here, silicon may be used as an example of the certain material. However, embodiments are not limited thereto. For example, silicon has properties such as heat resistance resulting in little change with temperature, non-oxidizing nature, resistance to various chemicals, water repellency, electrical insulation, or the like. However, even if it is not silicon, any material having the above-described characteristics may be applied (or coated) to the fifth wrapper 355.

The front-end plug 33 may be made of cellulose acetate. As an example, the front-end plug 33 may be generated by adding a plasticizer (e.g., triacetin) to the cellulose acetate tow. The mono denier of a filament constituting the cellulose acetate tow may be within a range of about 1.0 to about 10.0, for example, from about 4.0 to about 6.0. For example, the mono denier of the filament of the front-end plug 33 may be 5.0. In addition, the cross section of the filament constituting the front-end plug 33 may be a Y-shaped type. The total denier of the front-end plug 33 may be within a range of about 20,000 to about 30,000, for example, from about 25,000 to about 30,000. For example, the total denier of the front-end plug 33 may be 28,000.

In addition, as needed, the front-end plug 33 may include at least one channel, and the cross-sectional shape of the channel may be manufactured in various ways.

The tobacco rod 31 may correspond to the tobacco rod 21 described above with reference to FIG. 4. Therefore, the specific description of the tobacco rod 31 is omitted below.

The first segment 321 may be made of cellulose acetate. For example, the first segment may be a tube-shaped structure including a hollow inside. The first segment 321 may be produced by adding a plasticizer (e.g., triacetin) to the cellulose acetate tow. For example, the mono denier and the total denier of the first segment 321 may be the same as the mono denier and the total denier of the front-end plug 33.

The second segment 322 may be made of cellulose acetate. The mono denier of the filament constituting the second segment 322 may be within a range of about 1.0 to about 10.0, for example, from about 8.0 to about 10.0. For example, the mono denier of the filament of the second segment 322 may be 9.0. In addition, the cross-section of the filament of the second segment 322 may be a Y-shaped type. The total denier of the second segment 322 may be within a range of about 20,000 to about 30,000, for example, about 25,000.

FIG. 6 is a block diagram of an aerosol generating device 600 according to another embodiment.

The aerosol generating device 600 may include a controller 610, a sensing unit 620, an output unit 630, a battery 640, a heater 650, a user input unit 660, a memory 670, a communication unit 680, and a timer 690. However, the internal structure of the aerosol generating device 600 is not limited to those illustrated in FIG. 6. That is, according to the design of the aerosol generating device 600, it will be understood by one of ordinary skill in the art that some of the components shown in FIG. 6 may be omitted or new components may be added.

The sensing unit 620 may sense a state of the aerosol generating device 600 and a state around the aerosol generating device 600, and transmit sensed information to the controller 610. Based on the sensed information, the controller 610 may control the aerosol generating device 600 to perform various functions, such as controlling an operation of the heater 650, limiting smoking, determining whether an aerosol generating article (e.g., a cigarette, a cartridge, or the like) is inserted, displaying a notification, or the like.

The sensing unit 620 may include at least one of a temperature sensor 622, an insertion detection sensor, and a puff sensor 626, but is not limited thereto.

The temperature sensor 622 may sense a temperature at which the heater 650 (or an aerosol generating material) is heated. The aerosol generating device 600 may include a separate temperature sensor for sensing the temperature of the heater 650, or the heater 650 may serve as a temperature sensor. Alternatively, the temperature sensor 622 may also be arranged around the battery 640 to monitor the temperature of the battery 640.

The temperature sensor 622 may measure the temperature at which the heater 650 (or the aerosol generating material) is heated and provide the measured temperature to the controller 610. The controller 610 may calculate the time for the measured temperature to reach a temperature at which the aerosol generating material is volatilized by using the temperature sensor 622, and the humidity state of the cigarette 2 (see FIG. 2) may be determined by comparing the calculated temperature increase time with the preset threshold value. The controller 610 may control the power supplied to the heater 650 in response to the humidity state of the cigarette.

The insertion detection sensor 624 may sense insertion and/or removal of an aerosol generating article. For example, the insertion detection sensor 624 may include at least one of a film sensor, a pressure sensor, an optical sensor, a resistive sensor, a capacitive sensor, an inductive sensor, and an infrared sensor, and may sense a signal change according to the insertion and/or removal of an aerosol generating article.

The puff sensor 626 may sense a user's puff on the basis of various physical changes in an airflow passage or an airflow channel. For example, the puff sensor 626 may sense a user's puff on the basis of any one of a temperature change, a flow change, a voltage change, and a pressure change.

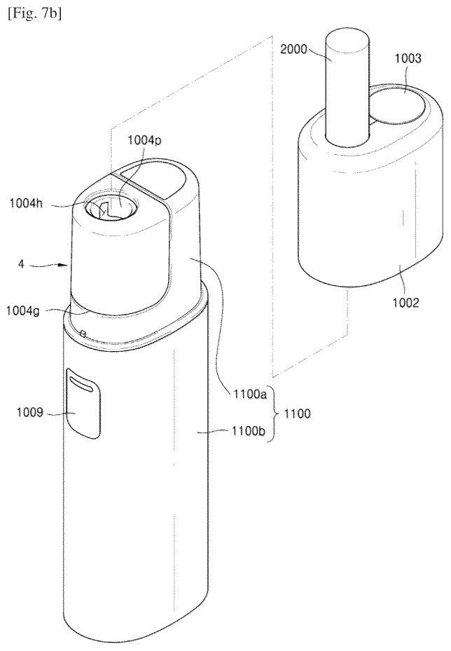

The humidity sensor 628 according to an embodiment may directly measure the amount of moisture contained in the cigarette 2 (see FIG. 2) and may provide information about the measured humidity to the controller 610. For example, the humidity sensor 628 may be arranged in the accommodating passage 1004h (see FIG. 7A) of the aerosol generating device 600. The humidity sensor 628 according to another embodiment may measure the amount of moisture condensed around the cigarette after heating the cigarette 2 (see FIG. 2). The amount of moisture evaporation during heating of over-humidified cigarettes may be greater than that of general cigarettes. Accordingly, more condensation may be caused when heating over-humidified cigarettes than when heating general cigarettes. For example, the humidity sensor 628 may be arranged around an outer hole 1002p (see FIG. 7A) overlapping the accommodating passage 1004h (see FIG. 7A) of the aerosol generating device 600 in a thickness direction or may be arranged at the door 1003 (see FIG. 7A).

The humidity sensor 628 may be one of an electric resistance sensor, a capacitive sensor, and an optical sensor. The above are merely examples, and the humidity sensor 628 is not limited thereto.

The sensing unit 620 may include, in addition to the temperature sensor 622, the insertion detection sensor 624, and the puff sensor 626 described above, at least one of a temperature/humidity sensor, a barometric pressure sensor, a magnetic sensor, an acceleration sensor, a gyroscope sensor, a location sensor (e.g., a global positioning system (GPS)), a proximity sensor, and a red-green-blue (RGB) sensor (illuminance sensor). Because a function of each of sensors may be intuitively inferred by one of ordinary skill in the art from the name of the sensor, a detailed description thereof may be omitted.

The output unit 630 may output information on a state of the aerosol generating device 600 and provide the information to a user. The output unit 630 may include at least one of a display unit 632, a haptic unit 634, and a sound output unit 636, but is not limited thereto. When the display unit 632 and a touch pad form a layered structure to form a touch screen, the display unit 632 may also be used as an input device in addition to an output device.

The display unit 632 may visually provide information about the aerosol generating device 600 to the user. For example, information about the aerosol generating device 600 may mean various pieces of information, such as a charging/discharging state of the battery 640 of the aerosol generating device 600, a preheating state of the heater 650, an insertion/removal state of an aerosol generating article, or a state in which the use of the aerosol generating device 600 is restricted (e.g., sensing of an abnormal object), or the like, and the display unit 632 may output the information to the outside. The display unit 632 may be, for example, a liquid crystal display panel (LCD), an organic light-emitting diode (OLED) display panel, or the like. In addition, the display unit 632 may be in the form of a light-emitting diode (LED) light-emitting device.

The haptic unit 634 may tactilely provide information about the aerosol generating device 600 to the user by converting an electrical signal into a mechanical stimulus or an electrical stimulus. For example, the haptic unit 634 may include a motor, a piezo-electric element, or an electrical stimulation device.

The sound output unit 636 may audibly provide information about the aerosol generating device 600 to the user. For example, the sound output unit 636 may convert an electrical signal into a sound signal and output the same to the outside.

The battery 640 may supply power used to operate the aerosol generating device 600. The battery 640 may supply power such that the heater 650 may be heated. In addition, the battery 640 may supply power required for operations of other components (e.g., the sensing unit 620, the output unit 630, the user input unit 660, the memory 670, and the communication unit 680) in the aerosol generating device 600. The battery 640 may be a rechargeable battery or a disposable battery. For example, the battery 640 may be a lithium polymer (LiPoly) battery, but is not limited thereto.

The heater 650 may receive power from the battery 640 to heat an aerosol generating material. Although not illustrated in FIG. 6, the aerosol generating device 600 may further include a power conversion circuit (e.g., a direct current (DC)/DC converter) that converts power of the battery 640 and supplies the same to the heater 650. In addition, when the aerosol generating device 600 generates aerosols in an induction heating method, the aerosol generating device 600 may further include a DC/alternating current (AC) that converts DC power of the battery 640 into AC power.

The controller 610, the sensing unit 620, the output unit 630, the user input unit 660, the memory 670, and the communication unit 680 may each receive power from the battery 640 to perform a function. Although not illustrated in FIG. 6, the aerosol generating device 600 may further include a power conversion circuit that converts power of the battery 640 to supply the power to respective components, for example, a low dropout (LDO) circuit, or a voltage regulator circuit.

In an embodiment, the heater 650 may be formed of any suitable electrically resistive material. For example, the suitable electrically resistive material may be a metal or a metal alloy including titanium, zirconium, tantalum, platinum, nickel, cobalt, chromium, hafnium, niobium, molybdenum, tungsten, tin, gallium, manganese, iron, copper, stainless steel, nichrome, or the like, but is not limited thereto. In addition, the heater 650 may be implemented by a metal wire, a metal plate on which an electrically conductive track is arranged, a ceramic heating element, or the like, but is not limited thereto.

In another embodiment, the heater 650 may be a heater of an induction heating type. For example, the heater 650 may include a suspector that heats an aerosol generating material by generating heat through a magnetic field applied by a coil.

In an embodiment, the heater 650 may include a plurality of heaters. For example, the heater 650 may include a first heater for heating a cigarette and a second heater for heating liquid.

The user input unit 660 may receive information input from the user or may output information to the user. For example, the user input unit 660 may include a key pad, a dome switch, a touch pad (a contact capacitive method, a pressure resistance film method, an infrared sensing method, a surface ultrasonic conduction method, an integral tension measurement method, a piezo effect method, or the like), a jog wheel, a jog switch, or the like, but is not limited thereto. In addition, although not illustrated in FIG. 6, the aerosol generating device 600 may further include a connection interface, such as a universal serial bus (USB) interface, and may connect to other external devices through the connection interface, such as the USB interface, to transmit and receive information, or to charge the battery 640.

The memory 670 is a hardware component that stores various types of data processed in the aerosol generating device 600, and may store data processed and data to be processed by the controller 610. The memory 670 may include at least one type of storage medium from among a flash memory type, a hard disk type, a multimedia card micro type memory, a card-type memory (for example, secure digital (SD) or extreme digital (XD) memory, etc.), random access memory (RAM), static random access memory (SRAM), read-only memory (ROM), electrically erasable programmable read-only memory (EEPROM), programmable read-only memory (PROM), a magnetic memory, a magnetic disk, and an optical disk. The memory 670 may store an operation time of the aerosol generating device 600, the maximum number of puffs, the current number of puffs, at least one temperature profile, data on a user's smoking pattern, etc.

The communication unit 680 may include at least one component for communication with another electronic device. For example, the communication unit 680 may include a short-range wireless communication unit 682 and a wireless communication unit 684.

The short-range wireless communication unit 682 may include a Bluetooth communication unit, a Bluetooth Low Energy (BLE) communication unit, a near field communication unit, a wireless LAN (WLAN) (Wi-Fi) communication unit, a Zigbee communication unit, an infrared data association (IrDA) communication unit, a Wi-Fi Direct (WFD) communication unit, an ultra-wideband (UWB) communication unit, an Ant+ communication unit, or the like, but is not limited thereto.

The wireless communication unit 684 may include a cellular network communication unit, an Internet communication unit, a computer network (e.g., local area network (LAN) or wide area network (WAN)) communication unit, or the like, but is not limited thereto. The wireless communication unit 684 may also identify and authenticate the aerosol generating device 600 within a communication network by using subscriber information (e.g., International Mobile Subscriber Identifier (IMSI)).

The timer 690 may output time information measured from a reference time. The timer 690 may count a clock signal of a predetermined frequency to generate and output time data according to the current time. The timer 690 may count the present date. For example, when the reference time is 0 o'clock of Jan. 1, 1970, the timer 690 may measure the flow of time from 0 o'clock of Jan. 1, 1970. When the reference time of the timer 690 is 0 o'clock of Jan. 1, 1970, under the assumption that 1 year has passed since the time 690 had started measuring time information, the timer 690 may output time information of 0 o'clock of Jan. 1, 1971.

The reference time of the timer 690 may be synchronized with the time when the aerosol generating device 600 is manufactured. In this case, the initial synchronization time may be determined by the supplier in the manufacturing process of the aerosol generating device 600, and the reference time of the timer 690 may be synchronized with an initial synchronization time.

The memory 670 may store visual information output from the timer 690. The memory 670 may receive and store visual information output from the timer 690 when the timer 690 starts measuring the visual information after the memory 670 is initialized at the manufacture or shipping time of the aerosol generating device 600.

The memory 670 may periodically store visual information output from the timer 690 according to any cycle, but embodiments are not limited thereto. The memory 670 may store visual information when a preset operation is performed. The preset operation may include at least one of resetting or booting of the controller 610, releasing of a shipping mode, ending an inhaling operation (e.g., the heating operation of a heater), starting a charging operation, or receiving a user input (e.g., a touch input or a button input), but embodiments are not necessarily limited. The controller 610 may store the visual information output from the timer 690 in the memory 670 when it is determined that the preset operation is performed.

The controller 610 may control general operations of the aerosol generating device 600. In an embodiment, the controller 610 may include at least one processor. The processor may be implemented as an array of a plurality of logic gates or may be implemented as a combination of a general-purpose microprocessor and a memory in which a program executable by the microprocessor is stored. It will be understood by one of ordinary skill in the art that the processor may be implemented in other forms of hardware.

The controller 610 may control the temperature of the heater 650 by controlling supply of power of the battery 640 to the heater 650. For example, the controller 610 may control power supply by controlling switching of a switching element between the battery 640 and the heater 650. In another example, a direct heating circuit may also control power supply to the heater 650 according to a control command of the controller 610.

The controller 610 may analyze a result sensed by the sensing unit 620 and control subsequent processes to be performed. For example, the controller 610 may control power supplied to the heater 650 to start or end an operation of the heater 650 on the basis of a result sensed by the sensing unit 620. As another example, the controller 610 may control, based on a result sensed by the sensing unit 620, an amount of power supplied to the heater 650 and the time the power is supplied, such that the heater 650 may be heated to a certain temperature or maintained at an appropriate temperature.

The controller 610 may control the output unit 630 on the basis of a result sensed by the sensing unit 620. For example, when the number of puffs counted through the puff sensor 626 reaches a preset number, the controller 610 may notify the user that the aerosol generating device 600 will soon be terminated through at least one of the display unit 632, the haptic unit 634, and the sound output unit 636.

The controller 610 may use the temperature sensor 622 to determine the humidity state of the cigarette. The controller 610 may operate the heater 650 according to a temperature profile corresponding to the determined humidity state of the cigarette.

The controller 610 may distinguish between a first season and a second season different from the first season based on the current date counted by the timer 690. The first season may be a season other than summer, and the second season may be summer. For example, the controller 610 may categorize June to August as the second season and categorize the rest of the year as the first season. However, the above is an example, and embodiments are not limited thereto. As another example, if the aerosol generating device is expected to be used in the southern hemisphere area (e.g., Australia), the period from December to February may be categorized as the second season and the rest of the year may be categorized as the first season.

Hereinafter, with reference to FIGS. 7A to 11, the aerosol generating device, which distinguishes between a general cigarette and an over-humidified cigarette based on a temperature increase time of the cigarette 2 (see FIG. 2) and applies a compensation profile when the cigarette corresponds to an over-humidified cigarette, and an operation method of the aerosol generating device will be described in detail.

FIG. 7A is a perspective view showing an exterior of the aerosol generating device according to an embodiment. FIG. 7B is a perspective view showing an operating state of an aerosol generating device from which some components are separated, according to the embodiment shown in FIG. 7A.

Referring to FIG. 7A, an aerosol generating device 1000 may include a case 1100 and a cover 1002. The cover 1000 may be coupled to one end of the case 1100 such that the case 1100 and the cover 1002 may together form the exterior of the aerosol generating device 1000.

The case 1100 forms a portion of the exterior of the aerosol generating device 1000 and accommodates various components therein to protect the various components.

The cover 1002 and the case 1100 may be formed of a plastic material with low conductivity, or a metal material of which a surface is coated with a heat-blocking material. The cover 1002 and the case 1000 may be, for example, formed by injection molding, three-dimensional (3D) printing, or assembling of small components formed by injection molding.

A maintaining device (not shown) for maintaining a coupling state of the cover 1002 and the case 1100 may be formed between the cover 1002 and the case 1100. The maintaining device may include, for example, a protrusion and a groove. The coupling state of the cover 1002 and the case 1100 may be maintained by maintaining a state in which the protrusion is inserted into the groove, and the protrusion may be separated from the groove as the protrusion moves according to a manipulation button to which pressure may be applied by the user.

In addition, the maintaining device may include, for example, a magnet and a metal member that adheres to the magnet. When a magnet is used in the maintaining device, a magnet may be installed in any one of the case 1100 and the cover 1002 and a metal member that adheres to the magnet may be installed in the other, or magnets may be installed in both the case 1100 and the cover 1002.

The outer hole 1002p through which a cigarette 2000 may be inserted may be formed in the upper surface of the cover 1002 coupled to the case 1100. Also, a rail 1003r may be formed on the upper surface of the cover 1002 to be adjacent to the outer hole 1002p. A door 1003 capable of a sliding movement along the upper surface of the cover 1002 may be formed at the rail 1003r. The door 1003 may linearly slide along the rail 1003r.

As the door 1003 is moved along the rail 1003r in the direction of the arrow of FIG. 7A, the outer hole 1002p and the insert hole 1004p may be exposed so that the cigarette 2000 may be inserted into the case 1100. The outer hole 1002p of the cover 1002 exposes the insert hole 1004p of the accommodating passage 1004h capable of accommodating the cigarette 2000 to the outside.

When the outer hole 1002p is exposed to the outside by the door 1003, the user may insert an end 2000b of the cigarette 2000 into the outer hole 1002p and the insert hole 1004p to mount the cigarette 2000 on the accommodating passage 1004h formed inside the cover 1002.

The rail 1003r may have a concave groove shape. However, according to an embodiment, the rail 1003r is not limited to a particular shape. For example, the rail 1003r may have a convex shape and may extend in a curved shape rather than a linear shape.

A button 1009 may be formed in the case 1100. As the button 1009 is manipulated, operations of the aerosol generating device 1000 may be controlled.

In a state in which the cover 1002 is coupled to the case 1100, an external air introduction interval 1002g allowing air to be introduced into the cover 1002 may be formed in a portion where the cover 1002 is coupled to the case 1100.

Referring to FIG. 7B, in a state in which the cigarette 200 is inserted into the aerosol generating device 1000, the user may take the cigarette 2000 into one's mouth to inhale the aerosol.

The case 1100 may include an upper case 1100a into which the cigarette 2000 is inserted to heat the cigarette 2000 and a lower case 1100b supporting and protecting various components mounted in the lower case 1100b. Hereinafter, the “case” 1100 denotes both of the upper case 1100a and the lower case 1100b.

The cover 1002 may be coupled to the case 1100 to cover the cigarette supporter 4 coupled to the case 1100. In addition, the cover 1002 may be separated from the case 1100 as necessary.

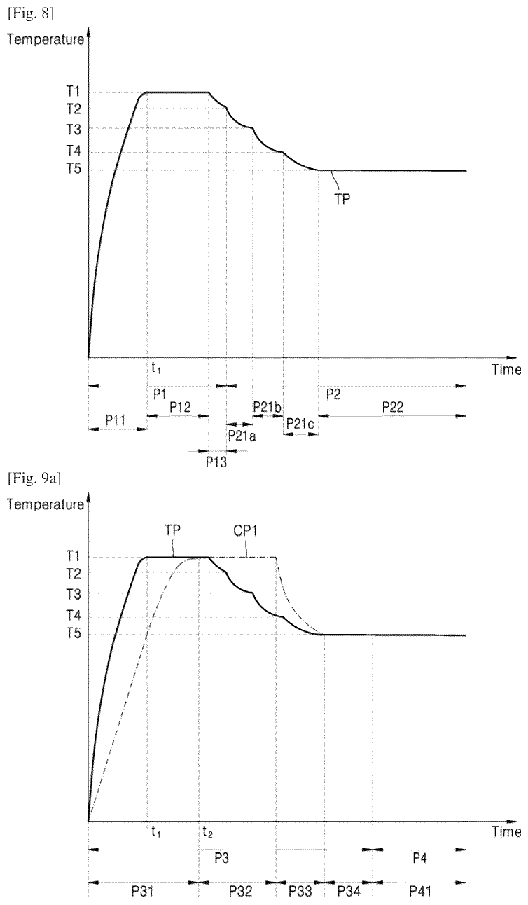

FIG. 8 is an example view for explaining the default temperature profile of the aerosol generating device.

Referring to FIGS. 6 and 8, the controller 610 of the aerosol generating device 600 may calculate a temperature increase time t1 of the cigarette 2000 (see FIG. 7A) by using the temperature sensor 622, and the humidity state of the cigarette 2000 may be determined by comparing the calculated temperature increase time t1 of the cigarette 2000 with a preset threshold value. The controller 610 may supply power to the heater 650 according to a default temperature profile TP when the temperature increase time T1 is less than the threshold value.

In this case, the preset threshold value, which is a time taken for the over-humidified cigarette to reach a first target temperature T1, may be determined by experiment. If the heater 650 is operated according to the default temperature profile TP even when the time for reaching the first target temperature T1 is equal to or greater than the threshold value, the user may feel hot because of the moisture included in the cigarette 2000.

In an embodiment, the controller 610 may set a threshold value based on the current date. In detail, the controller 610 may determine whether the current date belongs to the first season or the second season different from the first season based on the time counted by the timer 690. The first season may be a season other than summer, and the second season may be summer. The controller 610 may set the threshold value for the first season to a first threshold value and set the threshold value for the second season to a second threshold value. The second season is relatively hot and humid compared to the first season. In this regard, the controller may set the second threshold value to a smaller value than the first threshold value. For example, the first threshold value may be set to 22 seconds, and the second threshold value may be set to 20 seconds, which is smaller than the first threshold value.

As shown in FIG. 8, the default temperature profile TP includes a first preheating section P1 and a first smoking section P2, and the first preheating section P1 and the first smoking section P2 may be divided into subsections.

The first preheating section P1 may include a first preheating rising section P11 in which the temperature rises to the first target temperature T1 (corresponding to the temperature increase time t1), a first preheating maintaining section P12 in which the first target temperature T1 is maintained, and a first preheating descending section P13 in which the temperature descends to the second target temperature T2. The first smoking section P2 may include a 1-1^{st} smoking descending section P21a in which the temperature descends to the third target temperature T3, a 1-2^{nd} smoking descending section P21b in which the temperature descends to the fourth target temperature T4, a 1-3^{rd} smoking descending section P21c in which the temperature descends to the fifth target temperature T5, and a first smoking maintaining section P22 in which the fifth target temperature T5 is maintained. Here, as an example, the first preheating section P1 includes the first preheating rising section P11, the first preheating maintaining section P12, and the first preheating descending section P13. Also, the first smoking section P2 includes the 1-1^{st} smoking descending section P21b, the 1-3^{rd} smoking descending section P21c, and the first smoking maintaining section P22. However, embodiments are not limited thereto, and may be variously modified according to the shape and type of the cigarette or the heater.

FIG. 9A is an example view for explaining a first correction profile of the aerosol generating device.

Referring to FIGS. 6, 8, and 9A, when the aerosol generating device 600 determines that the inserted cigarette 2000 (see FIG. 7A) is an over-humidified cigarette, the aerosol generating device 2000 may apply the first correction profile CP1 described below to operate the heater 650.

The controller 610 according to an embodiment may calculate the temperature increase time t2 of the cigarette 2000 by using the temperature sensor 622, and may determine the humidity state of the cigarette 2000 by comparing the temperature increase time t2 of the cigarette 2000 with the preset threshold value. The controller 610 may supply power to the heater 650 according to the first correction profile CP1 when the temperature increase time t2 is greater than or equal to the threshold value.

However, the method of determining the humidity state of the cigarette 2000 is not limited thereto. The controller 610 according to another embodiment may determine the humidity state of the cigarette 2000 by using the humidity sensor 628.

The humidity sensor 628 may directly measure the amount of moisture contained in the cigarette 2000 and may provide information about the measured humidity to the controller 610. For example, the humidity sensor 628 may be arranged in the accommodating passage 1004h (see FIG. 7A) of the aerosol generating device 600. The humidity sensor 628 according to another embodiment may measure the amount of moisture condensed around the cigarette after heating the cigarette 2 (see FIG. 2). The amount of moisture evaporation during heating of over-humidified cigarettes may be greater than that of general cigarettes. Accordingly, more condensation may be caused when heating over-humidified cigarettes than when heating general cigarettes. For example, the humidity sensor 628 may be arranged around an outer hole 1002p (see FIG. 7A) overlapping the accommodating passage 1004h (see FIG. 7A) of the aerosol generating device 600 in a thickness direction or may be arranged at the door 1003 (see FIG. 7A).

The humidity sensor 628 may be one of an electric resistance sensor, a capacitive sensor, and an optical sensor. The above are merely examples, and the humidity sensor 628 is not limited thereto.

As shown in FIG. 9A, the first correction profile CP1 includes a second preheating section P3 and a second smoking section P4, and the second preheating section P3 and the second smoking section P4 may be divided into subsections.

The second preheating section P3 may include a second preheating rising section P31 (corresponding to a temperature increase time t2) in which the temperature rises to the first target temperature T1, a 2-1^{st} preheating maintaining section P32 in which the first target temperature T1 is maintained, a second preheating descending section P33 in which the temperature is descended to the fifth target temperature T5, and a 2-2^{nd} preheating maintaining section P34 in which the fifth target temperature T5 is maintained. The second smoking section P4 may include a second smoking maintaining section P41 in which the fifth target temperature T5 is maintained. Here, as an example, the second preheating section P3 includes the second preheating rising section P31, the 2-1^{st} preheating maintaining section P32, the second preheating descending section P33, and the 2-2^{nd} preheating maintaining section P34. Also, the second smoking section P4 includes the second smoking maintaining section P41. However, embodiments are not limited thereto, and may be variously modified according to the shape and type of the cigarette or the heater.

Referring to FIGS. 8 and 9A, the second preheating section P3 of the first correction profile CP1 may be longer than the first preheating section P1 of the default temperature profile TP.

In particular, the second preheating rising section P31 of the first correction profile CP1 may be longer than the first preheating rising section P11 of the default temperature profile TP. For example, the time t2 for the first correction profile CP1 to reach the first target temperature T1 and the time t1 for the default temperature profile TP to reach the first target temperature T1 may differ by about 3 to 4 seconds. That is, because over-humidified cigarettes contain a lot of moisture compared to general cigarettes, the temperature increase rate of the cigarette may become slow.

The 2-1^{st} preheating maintaining section P32 of the first correction profile CP1 may be longer than the first preheating maintaining section P12 of the default temperature profile TP. Accordingly, moisture inside the cigarette 2000 may evaporate more, thereby alleviating the initial hotness.

In addition, the temperature change in the second preheating descending section P33 of the first correction profile CP1 may be greater than the temperature change in the first preheating descending section P13 of the default temperature profile TP. For example, the first preheating descending section P13 may change from the first target temperature T1 to the second target temperature T2, whereas the second preheating descending section P33 may change from the first target temperature T1 to the fifth target temperature T5. Because the general cigarette includes less moisture than the over-humidified cigarette, it is less likely for the user to feel hotness due to the moisture included in the general cigarette as compared with the over-humidified cigarette Therefore, smoking with the general cigarette may be possible from the second target temperature T2, which is higher than the fifth target temperature T5. However, because the over-humidified cigarette includes more moisture therein than general cigarettes, in order to alleviate the initial hotness, the temperature change in the second preheating descending section P33 may be set to be greater than that of the first preheating descending section P13.

In addition, the second preheating section P3 of the first correction profile CP1 may further include a 2-2^{nd} preheating maintaining section P34 for maintaining the fifth target temperature T5 to alleviate the initial hotness.

FIG. 9B is an example view for explaining a second correction profile of the aerosol generating device.

Referring to FIGS. 6, 8, 9A, and 9B, the controller 610 of the aerosol generating device may distinguish between the first season and the second season different from the first season, based on the current date counted by the timer. The first season may be a season other than summer, and the second season may be summer. The controller 610 may supply power to the heater according to the first correction profile CP1 for the first season, and supply power to the heater according to the second correction profile CP2 for the second season.

As shown in FIG. 9B, the second correction profile CP2 includes a third preheating section P5 and a third smoking section P6. Also, a third preheating section P5 and a third smoking section P6 may be divided into subsections.

The third preheating section P5 of the second correction profile CP2 may include a third preheating rising section P51 (corresponding to temperature increase time t3) in which the temperature rises to a first target temperature T1, a 3-1^{st} preheating maintaining section P52 in which the first target temperature T1 is maintained, a third preheating descending section P53 in which the temperature is descended to the fifth target temperature T5, and a 3-2^{nd} preheating maintaining section P54 in which the fifth target temperature T5 is maintained. The third smoking section P6 may include a third smoking maintaining section P61 in which the fifth target temperature T5 is maintained. In this example, the third preheating section P5 includes the third preheating rising section P51, the 3-1^{st} preheating maintaining section P52, the third preheating descending section P53, and the 3-2^{nd} preheating maintaining section P54, and the third smoking section P6 includes the third smoking maintaining section P61. However, embodiments are not limited thereto, and may be variously modified according to the shape and type of the cigarette or the heater.

The third preheating section P5 of the second correction profile CP2 may be longer than the first preheating section P1 of the default temperature profile TP and shorter than the second preheating section P3 of the first correction profile CP1.

In particular, the 3-1^{st} preheating maintaining section P52 of the second correction profile CP2 may be longer than the first preheating maintaining section P12 of the default temperature profile TP. Accordingly, moisture inside the cigarette 2000 may evaporate more, thereby alleviating the initial hotness.

In addition, the temperature change in the third preheating descending section P53 of the second correction profile CP2 may be greater than the temperature change in the first preheating descending section P13 of the default temperature profile TP. For example, the first preheating descending section P13 may change from the first target temperature T1 to the second target temperature T2, whereas the third preheating descending section P53 may change from the first target temperature T1 to the fifth target temperature T5. In a general cigarette, there is low possibility for the user to feel the hotness due to moisture inside the cigarette. Therefore, inhaling at the second target temperature T2 higher than the fifth target temperature T5 is possible. However, because the over-humidified cigarette includes more moisture therein than general cigarettes, in order to alleviate the initial hotness, the temperature change in the second preheating descending section P33 may be set to be greater than that of the first preheating descending section P13.

In addition, the third preheating section P5 of the second correction profile CP2 may further include a 3-2^{nd} preheating maintaining section P54 for maintaining the fifth target temperature T5 to alleviate the initial hotness.

Because the second correction profile CP2 is used in the second season, the start temperature of the second correction profile CP2 may be higher than the start temperature of the first correction profile CP1. Therefore, the temperature increase time t3 for the second correction profile CP2 to reach the first target temperature T1 may be shorter than the temperature increase time t2 of the first correction profile CP1. In this case, because the aerosol generating device 600 initially maintains a high temperature, the user may feel hotness.

The second correction profile CP2 may relieve the initial hotness by including a longer preheating time after reaching the first target temperature T1 than the first correction profile CP1.

Referring to FIGS. 9A and 9B, the preheating time after reaching the first target temperature T1 of the second correction profile CP2 may be a period corresponding to a sum of the 3-1^{st} preheating maintaining section P52, the third preheating descending section P53, and the 3-2^{nd} preheating maintaining section P54. On the other hand, the preheating time after reaching the first target temperature T1 of the first correction profile CP1 may be a period corresponding to a sum of the 2-1^{st} preheating maintaining section P32, the second preheating descending section P33, and the 2-2^{nd} preheating maintaining section P34. Here, the period of a sum of the 3-1^{st} preheating maintaining section P52, the third preheating descending section P53, and the 3-2^{nd} preheating maintaining section P54 is greater than the period of a sum of the 2-1^{st} preheating maintaining section P32, the second preheating descending section P33, and the 2-2^{nd} preheating maintaining section P34. In other words, the third smoking section P6 of the second correction profile CP2 may be substantially similar to the second smoking section P4 of the first correction profile CP1.

In addition, the time of maintaining the first target temperature T1 of the second correction profile CP2 (i.e., the 3-1^{st} preheating maintaining section P52) may be less than the time of maintaining the first target temperature T1 of the first correction profile CP1 (i.e., the 2-1^{st} preheating maintaining section P32).

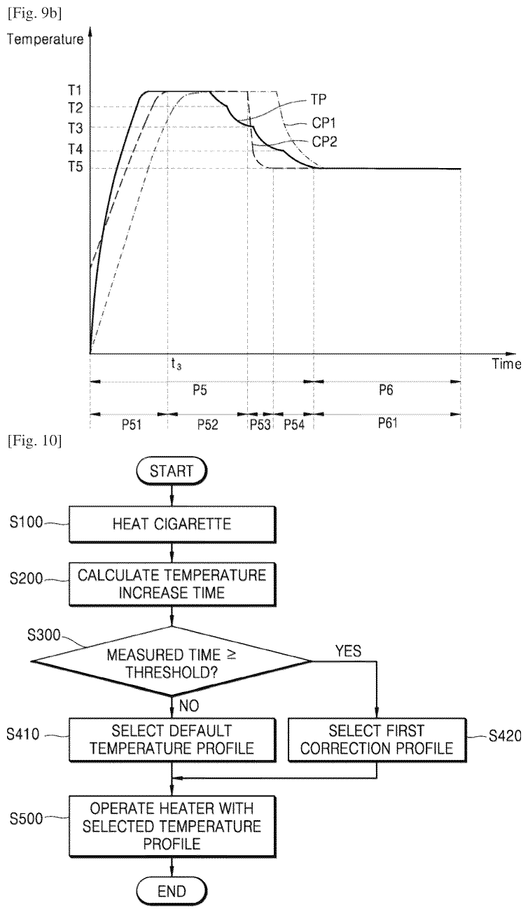

FIG. 10 is a flowchart illustrating an operation method of an aerosol generating device, according to an embodiment.

Referring to FIGS. 6 to 10, the operation method of the aerosol generating device may include heating the cigarette 2000 through the heater 650 (S100), calculating a temperature increase time of the cigarette 2000 by measuring the temperature of the heater 650 through the temperature sensor 622 (S200), determining the humidity state of the cigarette 2000 by comparing the calculated temperature increase time of the cigarette 2000 with a preset threshold value (S300), selecting a temperature profile corresponding to the determined humidity state of the cigarette 2000 (S410 and S420), and operating the heater 650 with the selected temperature profile (S500).

In particular, in the heating of the cigarette 2000 through the heater 650 S100, because the over-humidified cigarette contains a lot of moisture compared to the general cigarette, the temperature increasing speed of the cigarette may be slow as the evaporation of moisture is delayed.

In S200, the controller 610 may determine the time taken for the heater 650 to reach the preset first target temperature T1 as the temperature increase time of the cigarette 2000.

In S300, the controller 610 may determine that the cigarette 2000 is a general cigarette when the temperature increase time is less than the threshold value, and may determine that the cigarette 2000 is an over-humidified cigarette when the temperature increase time is greater than or equal to the threshold value.

Here, the preset threshold value may indicate a time taken for the over-humidified cigarette to reach a first target temperature T1, and may be determined by experiment. If the heater 650 is operated according to the default temperature profile TP even when the time for reaching the first target temperature T1 is equal to or greater than the threshold value, the user may feel the heat because of the moisture included in the cigarette 2000.

In S410 and S420, the controller 610 may select the default temperature profile TP if the temperature increase time is less than the threshold value S410, and may select the first correction profile TP1 when the temperature increase time is greater than or equal to the threshold value S420.

In S500, the controller 610 may supply power to the heater 650 according to the default temperature profile TP when the temperature increase time is less than the threshold, and may supply power to the heater 650 according to the first correction profile CP1 when the temperature increase time is greater than or equal to the threshold value.

The default temperature profile TP includes the first preheating section P1 and the first smoking section P2, and the first preheating section P1 and the first smoking section P2 may be divided into subsections. The first correction profile CP1 includes the second preheating section P3 and the second smoking section P4, and the second preheating section P3 and the second smoking section P4 may be divided into subsections.

The second preheating section P3 of the first correction profile CP1 may be longer than the first preheating section P1 of the default temperature profile TP.

In particular, the second preheating rising section P31 of the first correction profile CP1 may be longer than the first preheating rising section P11 of the default temperature profile TP.

The 2-1^{st} preheating maintaining section P32 may be longer than the first preheating maintaining section P12. Accordingly, moisture inside the cigarette 2000 may evaporate more, thereby alleviating the initial hotness.

In addition, the temperature change in the second preheating descending section P33 may be greater than the temperature change in the first preheating descending section P13. Because it is unlikely for the users to feel hotness from the moisture included in the general cigarette, it is possible to smoke at a second target temperature T2 higher than the fifth target temperature T5. However, because the over-humidified cigarette includes more moisture than general cigarettes, in order to alleviate the initial hotness, the temperature change in the second preheating descending section P33 may be set to be greater than that of the first preheating descending section P13.

In addition, the second preheating section P3 may further include the 2-2^{nd} preheating maintaining section P34 in which the fifth target temperature T5 is maintained to alleviate the initial hotness.

Those of ordinary skill in the art related to the present embodiments may understand that various changes in form and details can be made therein without departing from the scope of the characteristics described above. Therefore, the disclosed methods should be considered in a descriptive point of view, not a restrictive point of view. Therefore, the scope of the disclosure should be defined by the appended claims, and all differences within the scope equivalent to those described in the claims will be construed as being included in the scope of protection defined by the claims.

1. An aerosol generating device comprising:
a heater configured to heat a cigarette;
a temperature sensor configured to measure a temperature of the heater;
a timer configured to count a current date; and
a controller configured to:
calculate a temperature increase time of the cigarette by using the temperature sensor,
set a threshold value based on the current date,
when the temperature increase time is less than the threshold value, supply power to the heater according to a default temperature profile, and
when the temperature increase time is greater than or equal to the threshold value, supply power to the heater according to a first correction profile.

2. The aerosol generating device of claim 1, wherein the controller is further configured to distinguish between a first season and a second season different from the first season based on the current date, and set the threshold value to a first threshold value corresponding to the first season or to a second threshold value corresponding to the second season.

3. The aerosol generating device of claim 1, wherein
the default temperature profile comprises a first preheating section and a first smoking section,
the first correction profile comprises a second preheating section and a second smoking section, and
the second preheating section is longer than the first preheating section.

4. The aerosol generating device of claim 3, wherein
the first preheating section comprises a first preheating rising section, a first preheating maintaining section, and a first preheating descending section,
the second preheating section comprises a second preheating rising section, a 2-1^{st} preheating maintaining section, a second preheating descending section, and a 2-2^{nd} preheating maintaining section, and
the first preheating rising section is shorter than the second preheating rising section.

5. The aerosol generating device of claim 4, wherein
the 2-1^{st} preheating maintaining section is longer than the first preheating maintaining section, and
a temperature change in the second preheating descending section is greater than a temperature change in the first preheating descending section.

6. The aerosol generating device of claim 1, wherein the first smoking section comprises a first smoking descending section and a first smoking maintaining section, and the second smoking section comprises a second smoking maintaining section.

7. The aerosol generating device of claim 1, wherein the controller is further configured to:
distinguish between a first season and a second season different from the first season based on the current date,
supply power to the heater according to the first correction profile when the current date corresponds to the first season, and
supply power to the heater according to the second correction profile different from the first correction profile when the current date corresponds to the second season.

8. The aerosol generating device of claim 7, wherein
the first correction profile comprises a second preheating section and a second smoking section,
the second correction profile comprises a third preheating section and a third smoking section,
the second preheating section comprises a second preheating rising section, a 2-1^{st} preheating maintaining section, a second preheating descending section, and a 2-2^{nd} preheating maintaining section, and
the third preheating section comprises a third preheating rising section, a 3-1^{st} preheating maintaining section, a third preheating descending section, and a 3-2^{nd} preheating maintaining section, wherein
a time corresponding to a sum of the 2-1^{st} preheating maintaining section, the second preheating descending section, and the 2-2^{nd} preheating maintaining section is longer than a time corresponding to a sum of the 3-1^{st} preheating maintaining section, the third preheating descending section, and the 3-2^{nd} preheating maintaining section.

9. An operation method of an aerosol generating apparatus, the operation method comprising:
heating a cigarette by a heater;
measuring a temperature of the heater by a temperature sensor;
counting a current date by a timer; and
controlling power supplied to the heater through a control signal,
wherein the controlling of the power comprises:
calculating a temperature increase time of the cigarette by using the temperature sensor,
setting a threshold value based on the current date,
when the temperature increase time is less than the threshold value, supplying power to the heater according to a default temperature profile, and
when the temperature increase time is greater than or equal to the threshold value, supplying power to the heater according to a first correction profile.

10. The operation method of claim 9, wherein the controlling of the power comprises distinguishing between a first season and a second season different from the first season based on the current date, and setting the threshold value to a first threshold value corresponding to the first season or to a second threshold value corresponding to the second season.

11. The operation method of claim 9, wherein
the default temperature profile comprises a first preheating section and a first smoking section,
the first correction profile comprises a second preheating section and a second smoking section, and
the second preheating section is longer than the first preheating section.

12. The operation method of claim 11, wherein
the first preheating section comprises a first preheating rising section, a first preheating maintaining section, and a first preheating descending section,
the second preheating section comprises a second preheating rising section, a 2-1^{st} preheating maintaining section, a second preheating descending section, and a 2-2^{nd} preheating maintaining section, and
the first preheating rising section is shorter than the second preheating rising section.

13. The operation method of claim 12, wherein
the 2-1^{st} preheating maintaining section is longer than the first preheating maintaining section, and
a temperature change in the second preheating descending section is greater than a temperature change in the first preheating descending section.

14. The operation method of claim 9, wherein the controlling of the power comprises:
distinguishing between a first season and a second season different from the first season based on the current date;
supplying power to the heater according to the first correction profile when the current date corresponds to the first season; and
supplying power to the heater according to the second correction profile different from the first correction profile when the current date corresponds to the second season.

15. The operation method of claim 14, wherein
the first correction profile comprises a second preheating section and a second smoking section,
the second correction profile comprises a third preheating section and a third smoking section,
the second preheating section comprises a second preheating rising section, a 2-1^{st} preheating maintaining section, a second preheating descending section, and a 2-2^{nd} preheating maintaining section,
the third preheating section comprises a third preheating rising section, a 3-1^{st} preheating maintaining section, a third preheating descending section, and a 3-2^{nd} preheating maintaining section,
a time corresponding to a sum of the 2-1^{st} preheating maintaining section, the second preheating descending section, and the 2-2^{nd} preheating maintaining section is greater than a time corresponding to a sum of the 3-1^{st} preheating maintaining section, the third preheating descending section, and the 3-2^{nd} preheating maintaining section.
